(19) United States
(12) Patent Application Publication
(10) Pub. No.: US 2008/0135263 A1
(43) Pub. Date: Jun. 12, 2008

(54) Fire Protection Induction System

(76) Inventor: Graham Douglas Millard, Victoria (AU)

Correspondence Address: MILES & STOCKBRIDGE PC, 1751 PINNACLE DRIVE, SUITE 500, MCLEAN, VA, 22102-3833, US

(21) Appl. No.: 11/815,558

(22) PCT Filed: Feb. 3, 2006
(86) PCT No.: PCT/AU06/00138

§ 371 Date: Mar. 3, 2008

(30) Foreign Application Priority Data
Feb. 4, 2005 (AU) 2005900507

(51) Int. Cl. A62C 5/00; G05D 11/00; F17D 1/20

(52) U.S. Cl. 169/44; 137/87.06; 137/7; 137/10

(57) ABSTRACT

A method of combining a first fluid from a first source (1) with a second fluid from a second source (16) in a de-sired ratio, by measuring the flow rate and pressure of the first fluid (at 12 and 14) prior to combining (at 10), and determining from this the desired flow rate and pressure at which the second fluid should be added to achieve the desired ratio. The pressure and flow rate of the second fluid is measured (at 6 and 8) and provides a feedback loop to ensure that the second fluid is being added at the desired flow rate and pressure to achieve the desired ratio. The pressure and flow rate of the second fluid may be controlled by multiple pumps 2 of different power.

### FIELD OF THE INVENTION

The present invention relates broadly to a method and apparatus for adding a first fluid to a second fluid in a conduit network to form a mixture having predetermined proportions of those fluids. The invention relates particularly, though not exclusively, to induction systems suitable for use with fire protection systems, for example fire protection systems which operate through mixing a proportion of a fire retardant concentrate with a water stream for subsequent release through a distribution network.

### BACKGROUND OF THE INVENTION

Damage from fire is a significant economic cost to both the individuals whose property or person has been affected by the fire, and society which has to allocate resources to fire protection equipment and personnel. Automated fire protection systems have been developed to reduce the response time to a fire and minimise any property damage.

One type of automated fire protection system is an automatically activated sprinkler system, which comprises a network of pipes ending in sprinklers fixed to the ceiling of the protected premises. When a fire is detected, fire-retardant agents are released from the sprinkler system to extinguish the fire. Flooding systems are another type of fire protection system which can also be used to release fire-retardant agents in the proximity of a fire.

A variety of fire-retardant agents are used with sprinkler and flooding systems, and the appropriateness and effectiveness of fire-retardant agents is often dependent on the type of combustible material involved in the fire. In some sprinkler systems, the fire-retardant agents are created “on-the-fly” by mixing two or more constituent materials. For example, in foam-based sprinkler systems, a fire-retardant foam concentrate is stored separately from the water and is mixed as required by the fire protection system.

In such systems, the mixing of the constituent materials is often imprecise and inexact, thereby reducing the effectiveness of the resulting fire-retardant agent and potentially increasing the total costs of the system (for example, by mixing more fire-retardant agent concentrate than required with the water).

### SUMMARY OF THE INVENTION

In a first aspect, the present invention provides a method for adding a first fluid to a second fluid at an addition location in a conduit network to form a mixture having a predetermined proportion of the first fluid to the second fluid, the first and second fluids flowing from respective first and second sources to the addition location, the method comprising the steps of:
measuring the flow rate and pressure of the second fluid at a location between the second source and the addition location;
determining a desired flow rate and pressure of the first fluid based on the measured flow rate and pressure of the second fluid;
measuring the flow rate and pressure of the first fluid at a location between the first source and the addition location;
determining the difference in flow rate and pressure between the measured flow rate and pressure of the first fluid and the desired flow rate and pressure;
controlling the rate at which the first fluid is added to the second fluid dependent on the measured differential flow rate and pressure to obtain the predetermined proportion of the first and second fluids in the mixture.

Further, in a second aspect, the present invention provides a method for adding a first fluid to a second fluid at an addition location in a conduit network to form a mixture having a predetermined proportion of the first fluid to the second fluid, the first and second fluids flowing from respective first and second sources to the addition location, the method comprising the steps of:
measuring the flow rate and pressure of the second fluid at a location between the second source and the addition location;
determining a desired flow rate and pressure of the first fluid at a location between the first source and the addition location, said desired flow rate and pressure being dependent on the measured flow rate and pressure of the second fluid; and
adding the first fluid to the second fluid at a flow rate and pressure based upon the desired flow rate and pressure.

Moreover, in a third aspect, the present invention provides an apparatus for controlling the amount of a first fluid from a first source added to a second fluid from a second source at an addition location to form a mixture, the apparatus comprising:
a second pressure sensor for measuring the pressure of the second fluid at a location between the second source and the addition location;
a second flow sensor for measuring the flow rate of the second fluid at a location between the second source and the addition location;
a first pressure sensor for measuring the pressure of the first fluid at a location between the first source and the addition location;
a first flow sensor for measuring the flow rate of the first fluid at a location between the first source and the addition location;
means for determining a desired flow rate and pressure of the first fluid dependent on measured flow rate and pressure of the second fluid;
means for determining the difference between the measured flow rate and pressure of the first fluid and the desired flow rate and pressure; and
means for controlling the rate at which the first fluid is added to the second fluid dependent on the measured differential flow rate and pressure and to obtain a predetermined proportion of the first and second fluids in the mixture.

Finally, in a fourth aspect, the present invention provides a method for controlling the amount of fire-retardant concentrate flowing from a concentrate source and added at an addition location to water flowing through a pipe network to form a fire-retardant mixture for dispersal through apertures in the pipe network, the method comprising the steps of:
measuring the flow rate and pressure of the water in the pipe network upstream of the addition location;
determining a desired flow rate and pressure of the fire retardant concentrate;
measuring the flow rate and pressure of the fire retardant concentrate at a location between the concentrate source and the addition location;
determining the difference in flow rate and pressure between the desired flow rate and pressure and the measured flow rate and pressure of the fire retardant concentrate; and
controlling the rate at which fire retardant concentrate is added to the water dependent on the measure differential flow rate and pressure and to obtain a predetermined proportion of the water and the fire retardant concentrate in the fire retardant mixture.

### BRIEF DESCRIPTION OF THE FIGURES

FIG. 1 is a diagrammatic illustration of an embodiment of an apparatus according to the invention and including a portion of a conduit network and attached fire-retardant foam induction system.

### DETAILED DESCRIPTION OF THE PREFERRED EMBODIMENT

The methods and apparatus of the present invention are preferably used to accurately control the proportion of fire-retardant concentrate added to a water stream for dispersal in an area in which a fire may be occurring.

In a typical sprinkler system, a second fluid, water, is pumped from a second source (a water tank or water mains) through a conduit sprinkler network. The water travels through the network to exit apertures in the form of sprinkler heads. The sprinkler heads disperse the water over the desired area. An alternative to a sprinkler system is a flooding system which floods the area with water (or other fire-retardant).

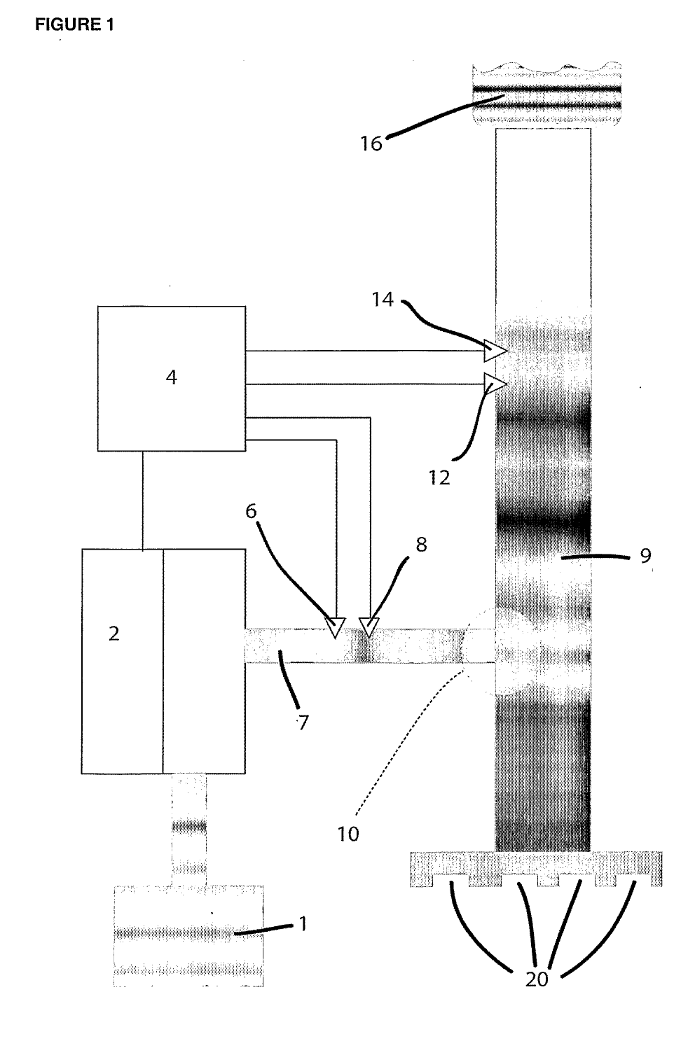

In the preferred embodiment as illustrated in FIG. 1, a first source 1 in the form of one or more tanks of fire-retardant concentrate are installed in or near the building to be protected from fire. The fire-retardant concentrate is a first fluid that is added to the second fluid (water).

The fire-retardant concentrate tanks 1 are connected by a hose or tube 7 to the conduit sprinkler network 9 at an addition location 10. The addition location 10 is located between the second source 16 (the water tank or water mains) and the exit apertures 20 (sprinkler heads). When a sprinkler is triggered, fire-retardant concentrate is added to the water at the addition location 10 to form a fire-retardant mixture. The fire-retardant mixture is then dispersed through the sprinkler heads 20.

The amount of fire-retardant concentrate should be carefully controlled to ensure that sufficient concentrate is added to the water stream to form an effective fire-retardant mixture, and which avoids the addition of an excess of fire-retardant concentrate (which decreases the effectiveness of the fire-retardant mixture and/or which increases fire-retardant concentrate costs). Effective fire-retardant mixtures are created by maintaining a predetermined proportion of fire-retardant concentrate to water. For example for some fire-retardants the volume of fire-retardant concentrate which should be added is 3% of the water volume.

The apparatus includes controlling means 4 in the form of a programmable logic controller (PLC) configured to control the amount of fire-retardant concentrate that is added to the water stream at the addition location 10. The PLC 4 is connected to a second pressure sensor 12 and a second water flow sensor 14 installed at a location between the second source 16 (the water tanks or mains) and the addition location 10. The second pressure sensor 12 measures the water pressure before the fire-retardant concentrate is added to it, while the second water flow sensor 14 measures the rate at which the water is flowing towards the addition location 10 (in cubic metres per second). The PLC 4 is also connected to a first pressure sensor 6 and first flow rate sensor 8 installed at locations between the first source 1 (the tanks containing the fire-retardant concentrate) and the addition location 10. These sensors measure the pressure and flow rate of the fire-retardant concentrate.

When the sprinkler system is activated, water flows through the conduit network 9 from the water tank or mains 16 to the sprinkler heads 20. The second pressure and water flow sensors (12 and 14) measure the pressure and flow rate of the water respectively. These measurements are read by the PLC 4.

The PLC 4 determines a desired flow rate of the fire-retardant concentrate by calculating a proportion of the water flow rate. For some fire-retardants, this proportion is around 3%. For example, if the water flow rate is 100 m³/sec, the desired flow rate of the fire-retardant concentrate will be 3 m³/sec.

The PLC 4 determines a desired pressure of the fire-retardant concentrate by calculating a proportion of the measured water pressure. In order to ensure that the fire-retardant concentrate can be added to the water, the pressure of the fire-retardant concentrate must by higher than that of the water. Typically, the desired pressure of the fire-retardant concentrate is approximately 5% higher than the measured water pressure. For example, if the water pressure is 100 kPa, the desired pressure of the fire-retardant concentrate is 105 kPa.

The desired flow rate and pressure of the fire-retardant concentrate is calculated to result in a mixture with the predetermined proportions of water to fire-retardant concentrate.

The control means of the embodiment also includes at least two pumps 2 having different power capacities. The pumps are operatively coupled to and controlled by the PLC 4. The larger capacity pump is used to add fire-retardant concentrate at approximately the desired rate to obtain the desired fire-retardant pressure and flow rate. The smaller capacity pump is used to fine tune the rate at which fire-retardant concentrate is added to the water. In many installations only a single pump may be required.

The PLC 4, having determined the desired flow rate and pressure of the fire-retardant concentrate, controls the pumps 2 to supply the fire-retardant concentrate at the desired flow rate and pressure.

The PLC 4 obtains feedback from the first flow rate and pressure sensors (8 and 6), which continuously measure the flow rate and pressure of the fire-retardant concentrate. If for any reason the measured flow rate and pressure of the fire-retardant concentrate differs from the desired flow rate and pressure, the PLC 4 controls the pumps 2 to reduce the difference.

Similarly, any changes in water pressure (caused, for example, by more sprinkler heads being activated) is compensated for by the PLC 4, which recalculates the desired fire-retardant concentrate flow rate and pressure and controls the one or more pumps 2 to add the fire-retardant concentrate at a rate which compensates for the difference between the desired fire-retardant concentrate flow rate and pressure and the measured fire-retardant flow rate and pressure as measured by the first flow rate sensor 8 and pressure sensor 6 respectively.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

All publications mentioned in this specification are herein incorporated by reference. Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia or elsewhere before the priority date of each claim of this application.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A method for adding a first fluid to a second fluid at an addition location in a conduit network to form a mixture having a predetermined proportion of the first fluid to the second fluid, the first and second fluids flowing from respective first and second sources to the addition location, the mixture flowing from the addition location to one or more exit apertures, the method comprising the steps of:
measuring the flow rate and pressure of the second fluid at a location between the second source and the addition location;
determining a desired flow rate and pressure of the first fluid based on the measured flow rate and pressure of the second fluid;
measuring the flow rate and pressure of the first fluid at a location between the first source and the addition location;
determining the difference in flow rate and pressure between the measured flow rate and pressure of the first fluid and the desired pressure and flow rate; and
controlling the rate at which the first fluid is added to the second fluid dependent on the measured differential flow rate and pressure to obtain the predetermined proportion of the first and second fluids in the mixture.

2. A method as claimed in claim 1, wherein the steps of measuring the flow rate and pressure of the second fluid, determining a desired flow rate and pressure of the first fluid, measuring the flow rate and pressure of the first fluid, and determining the difference in flow rate and pressure are performed continuously.

3. A method as claimed in claim 1, wherein the first fluid is a foam concentrate.

4. A method as claimed in claim 1, wherein the second fluid is water.

5. A method as claimed in claim 1, wherein the first fluid is a fire-retardant.

6. A method as claimed in claim 1, wherein a programmable logic controller is used to determine the difference in flow rate and pressure between the desired flow rate and pressure and the measured flow rate and pressure of the first fluid, and control the amount of the first fluid added to the second fluid.

7. A method as claimed in claim 1, wherein the step of adding the first fluid to the second fluid is performed under positive pressure by using one or more pumps.

8. A method as claimed in claim 7, wherein the step of adding the first fluid to the second fluid is performed under positive pressure by using two or more pumps having differing power capacities.

9. A method for adding a first fluid to a second fluid at an addition location in a conduit network to form a mixture having a predetermined proportion of the first fluid to the second fluid, the first and second fluids flowing from respective first and second sources to the addition location, the method comprising the steps of:
measuring the flow rate and pressure of the second fluid at a location between the second source and the addition location;
determining a desired flow rate and pressure of the first fluid at a location between the first source and the addition location, said desired flow rate and pressure being dependent on the measured flow rate and pressure of the second fluid; and
adding the first fluid to the second fluid at a rate and pressure based upon the desired flow rate and pressure.

10. A method as claimed in claim 9, further comprising the subsequent steps of:
measuring the flow rate and pressure of the first fluid at a location between the first source and the addition location;
determining the difference in flow rate and pressure between the measured flow rate and pressure of the first fluid and the desired flow rate and pressure;
controlling the rate at which the first fluid is added to the second fluid dependent on the measured differential flow rate and pressure and the predetermined proportion of the first fluid and the second fluid in the mixture.

11. A method as claimed in claim 10, wherein the steps of measuring the flow rate and pressure of the first fluid, determining the difference in flow rate and pressure and controlling the rate at which the first fluid is added to the second fluid are performed continuously.

12. A method as claimed in claim 9, wherein the first fluid is a foam concentrate.

13. A method as claimed in claim 9, wherein the second fluid is water.

14. A method as claimed in claim 9, wherein the first fluid is a fire-retardant.

15. A method as claimed in claim 9, wherein a programmable logic controller is used to determine the desired pressure and flow rate of the first fluid.

16. A method as claimed in claim 9, wherein the step of adding the first fluid to the second fluid is performed under positive pressure by using a pump.

17. A method as claimed in claim 9, wherein the step of adding the first fluid to the second fluid is performed under positive pressure by using two or more pumps having different power capacities.

18. An apparatus for controlling the amount of a first fluid from a first source added to a second fluid from a second source at an addition location to form a mixture, the apparatus comprising:
a second pressure sensor for measuring the pressure of the second fluid at a location between the second source and the addition location;
a second flow rate sensor for measuring the flow rate of the second fluid at a location between the second source and the addition location;
a first pressure sensor for measuring the pressure of the first fluid at a location between the first source and the addition location;
a first flow rate sensor for measuring the flow rate of the first fluid at a location between the first source and the addition location;
means for determining a desired flow rate and pressure of the first fluid dependent on the measured flow rate and pressure of the second fluid;
means for determining the difference between the measured flow rate and pressure of the first fluid and the desired flow rate and pressure; and
means for controlling the rate at which the first fluid is added to the second fluid dependent on the measured differential flow rate and pressure and to obtain a predetermined proportion of the first and second fluids in the mixture.

19. An apparatus as claimed in claim 18, wherein the determining means and the controlling means includes a programmable logic controller.

20. An apparatus as claimed in claim 19, wherein the programmable logic controller is configured to determine a desired flow rate and pressure of the first fluid at a location between the first source and the addition location, said flow rate and pressure being dependent on the predetermined proportions of the first and second fluids in the mixture.

21. A system as claimed in claim 18, wherein the first fluid is a foam concentrate.

22. A system as claimed in claim 18, wherein the second fluid is water.

23. A system as claimed in claim 18, wherein the first fluid is a fire-retardant.

24. A system as claimed in claim 18, wherein the controlling means includes a pump.

25. A method for controlling the amount of fire-retardant concentrate flowing from a concentrate source and added at an addition location to water flowing through a pipe network to form a fire-retardant mixture for dispersal through apertures in the pipe network, the method comprising the steps of:
measuring the flow rate and pressure of the water in the pipe network upstream of the addition location;
determining a desired flow rate and pressure of the fire-retardant concentrate;
measuring the flow rate and pressure of the fire-retardant concentrate at a location between the concentrate source and the addition location;
determining the difference in flow rate and pressure between the desired flow rate and pressure and the measured flow rate and pressure of the fire-retardant concentrate; and
controlling the rate at which the fire retardant concentrate is added to the water dependent on the measured differential flow rate and pressure and to obtain a predetermined proportion of the water and the fire-retardant concentrate in the fire retardant mixture.

26. A method as claimed in claim 25, wherein a programmable logic controller is used to determine the difference in flow rate and pressure between the desired flow rate and pressure and the flow rate and pressure of the fire-retardant concentrate as measured between the concentrate source and the addition location, and control the amount of fire-retardant concentrate added to the water.

27. A method as claimed in claim 25, wherein the step of adding the fire-retardant concentrate to the water is performed under positive pressure by using one or more pumps.

28. A method as claimed in claim 27, wherein the step of adding the fire-retardant concentrate to the water is performed under positive pressure by using two or more pumps having differing power capacities.
